(19) United States
(12) Patent Application Publication
(10) Pub. No.: US 2004/0088588 A1
(43) Pub. Date: May 6, 2004

(54) Limited resource access while power-on-password is active

(75) Inventors: Faisal M. Awada, Round Rock, TX (US); Joe Nathan Brown, Austin, TX (US); Herman Rodriguez, Austin, TX (US); Newton James Smith JR., Austin, TX (US)

Correspondence Address: Greg Goshorn, P.C., Attn: Greg Goshorn, Suite 115-119, 2110 W. Slaughter Lane, Austin, TX, 78748, US

(73) Assignee: International Business Machines Corporation, Armonk, NY

(21) Appl. No.: 10/286,610

(22) Filed: Oct. 31, 2002

(51) Int. Cl. H04L 9/32

(52) U.S. Cl. 713/202

(57) ABSTRACT

A method of rapid access to resources on a computing system is provided that differentiates between applications, data and devices that require password protection and those that do not, enabling those applications, data and devices that do not require protection to be accessed without entry of a password. In one embodiment, application programs include an option that enables a user to specify whether or not the application, or specific operations within the application, can be initiated without first entering a password. In a second embodiment, the protection is provided at an operating system level by protecting designated resources. Another embodiment employs two passwords—the second of which is required to access rapid access applications or operations and may or may not timeout. In this manner, an authorized user can gain access to particular applications, data or devices in less time than otherwise necessary with a standard password protection scheme.

### TECHNICAL FIELD

The present invention relates generally to an access control scheme in a computing system and, more specifically, to a method of enabling limited access to selected computing applications, data and devices prior to entry of access control data.

### BACKGROUND OF THE INVENTION

Handheld and tablet computers, personal digital assistants (PDAs) and cell phones are examples of computing devices that have been widely adopted by consumers and, in some cases, become indispensable personal accessories. These types of computing devices are used to store both personal and work-related information. Sometimes, information stored or accessible through these devices must be protected from access by unauthorized parties. One of the primary methods for ensuring the privacy of such information is the use of a power-on password, typically implemented in a particular computing device's hardware and basic input/output system (BIOS). When the computing device is first turned on or has been inactive for a certain period of time, a user must enter this power-on password to access the device. In this manner, a user who does not know the correct password is denied access to the computing device's applications and data.

While a power-on password is useful in protecting the authorized user's data from inappropriate access, the time required to enter the password may create problems by preventing quick access to the computing device. For example, if the user wants to quickly save the license plate number of a passing automobile and attempts to enter the number on a PDA that has either been turned off or has “timed-out,” the time it takes to enter the password may be enough time to forget the license plate number. Exacerbating the problem, the time necessary to enter the password may be lengthened due to a particular device's less than optimal input/output system, e.g. a stylus-based system used by many PDAs. The user may also temporarily forget the correct password or, due to the need for speed, enter the password incorrectly one or more times. In fact, using the license plate example, it may take longer to enter the password than it takes to enter and save the license plate number, provided the license plate number can be remembered after entry of the password.

### SUMMARY OF THE INVENTION

A method of and system for rapid access to resources on a computing system are provided that differentiate between applications, data and devices that require access control protection and those that do not, enabling those resources that do not require protection to be accessed without entry of access control data. Access control data includes but is not limited to passwords, such as a series of alphanumeric characters; overt acts, such as a predefined series of mouse clicks in a particular region(s) of a display; and the output of biometric devices such as a fingerprint reader and an iris scanner.

One common type of password protection is the use of a “power-on” password. Examples of computing devices that provide power-on password protection include but are not limited to handheld computers, personal digital assistants (PDAs), tablet devices, laptop and desktop computers. In a system according to the disclosed embodiments, a user designates certain applications as “rapid access,” i.e. able to be accessed without entry of a power-on password even though the computing device has timed out or just been turned on and is otherwise requiring the entry of the password. Examples of potential rapid access applications include but are not limited to calculator programs, memo pad and games. Examples of rapid access devices include but are not limited to a printer, a GPS device and an infrared device. In addition, particular functions or operations within specific applications, such as the creation of new records in email, expense reports, scheduling programs, and address books, can be designated as rapid access operations. Examples of operations that might not be designated as rapid access include read and update operations on data records already stored by the email, expense report, scheduling or address books programs.

In one embodiment of the claimed subject matter, an application program includes an option that enables a user to specify whether the application, or specific operations within the application, can be initiated without first entering a password. When the computing device enters a “restricted mode” the operating system sends a message to the application so that the application takes appropriate action in the event a user attempts to access protected data or functions. In another embodiment, individual data records are designated as password protected and the default protection scheme allows the initiation of applications or the access of data without requiring the entry of a password. In this embodiment, the user has read access to certain records even though the device is currently under password protection.

In an alternative embodiment, a second password, referred to herein as a “rapid access password,” is required to access the rapid access applications or operations. The rapid access password can be considerably shorter than a first, standard password required for full access to a device. For example, the rapid access password may include a series of actions as simple as double tapping in one particular, user-specified area of the device's display or pressing a particular button. In this manner, an authorized user can gain access to particular resources more quickly than otherwise necessary with a standard password protection scheme. It should be noted that, although the following description makes use of a password protection scheme defined by keystrokes, the techniques of the disclosed embodiments may be implemented in a number of access control schemes. For example, the rapid access password scheme may include a prearranged series of mouse clicks.

The rapid access protection scheme of the present invention provides enhanced security for a computing device because it makes it more likely that a user will utilize the power-on password feature of a computing device. Currently, the only way a user can simultaneously provide rapid access and data protection is to disable the power-on password entirely and then protect individual records. This “ad hoc” scheme may protect individual records but cannot prevent unauthorized access to specific applications or functions within those applications. Obviously, the ad hoc protection scheme has drawbacks that are eliminated by the methods of the disclosed embodiment.

### BRIEF DESCRIPTION OF THE DRAWINGS

A better understanding of the present invention can be obtained when the following detailed description of the disclosed embodiments is considered in conjunction with the following drawings, in which:

FIGS. 1A and 1B illustrate two exemplary computing devices implemented according to the present invention;

FIG. 2 is a flow chart showing a start-up and initialization routine of the present invention;

FIG. 3 is a flow chart showing an exemplary operation of a restricted mode and an unrestricted mode of the present invention;

FIG. 4 is a flow chart showing an initiation of an application in a computing device implemented according to the present invention; and

FIG. 5 is a flow chart of a “rapid access” password scheme that enhances the functionality of a typical password scheme.

### DETAILED DESCRIPTION OF THE PREFERRED EMBODIMENT

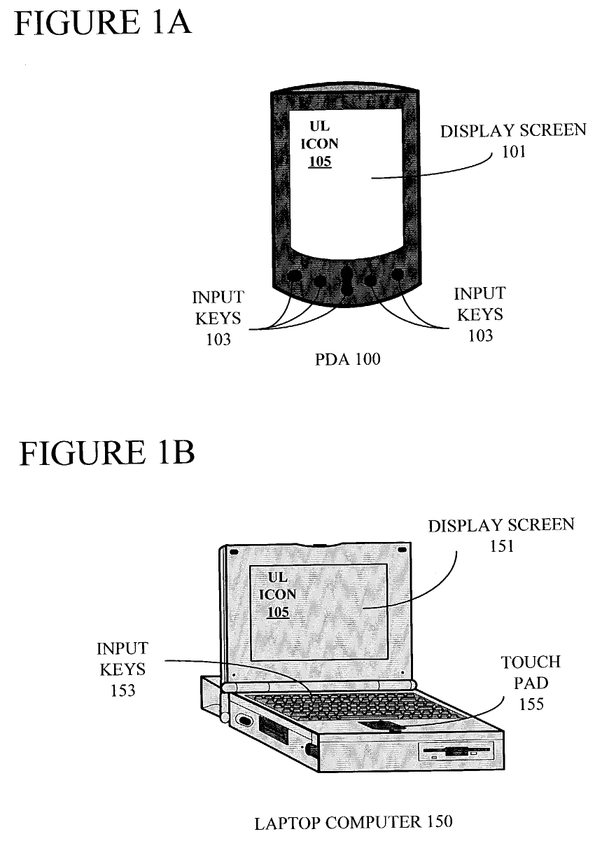

Although described with particular reference to a personal digital assistant (PDA) and a laptop computer, the access limiting system and method of the present invention can be implemented in any system in which access control is desirable. In addition, the system and method are not limited to access control systems that employ a typewritten password. FIGS. 1A and 1B illustrate two exemplary platforms in which the system according to the present invention can be implemented. Those with skill in the computing arts will recognize that the disclosed embodiments have relevance to a wide variety of platforms in addition to those described below. In addition, the access limiting system of the present invention can be implemented in software, hardware, or a combination of software and hardware. The hardware portion can be implemented using specialized logic; the software portion can be stored in a memory and executed by a suitable instruction execution system such as a microprocessor.

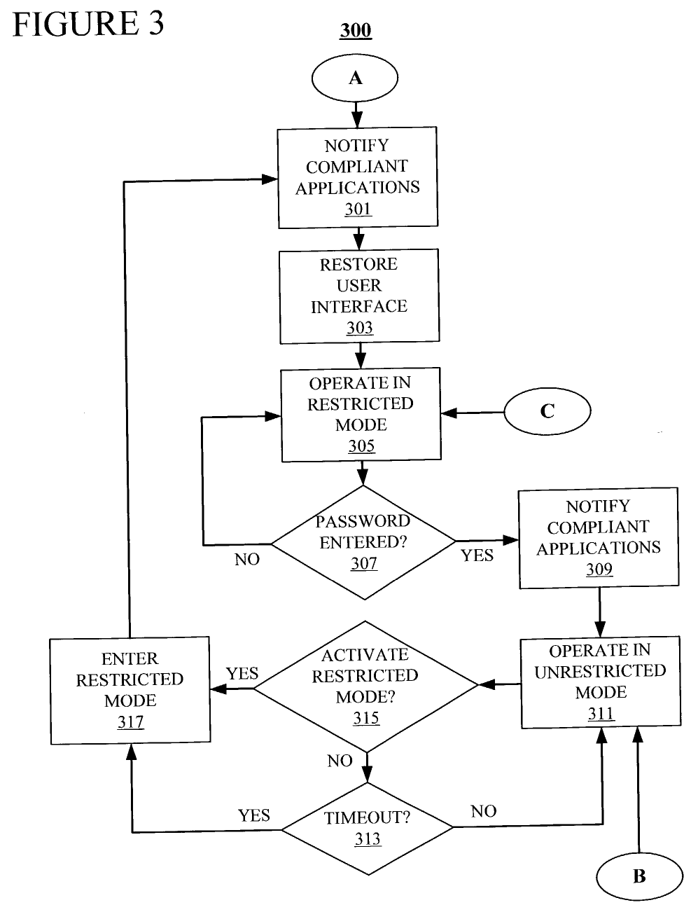

FIG. 1A illustrates a PDA device 100, which includes a display screen 101 and input keys 103. Typically, a user of PDA 100 enters data by means of either the input keys 103 and/or a stylus (not shown), which is touched to the display screen 101. The stylus is used to write data directly onto the screen 101 or used to select an application by touching an icon such as an Unlock (UL) icon 105 displayed on the screen 101. The function of UL icon 105 is described in more detail below in conjunction with FIG. 3.

FIG. 1B illustrates a laptop computer 150, which includes a display screen 151, input keys 153 and a touch pad 155. The use of the display 151, keys 153 and touch pad 155 should be familiar to those with computing experience. Like PDA 100, the laptop computer 150 includes UL icon 105, which is displayed on the display screen 151.

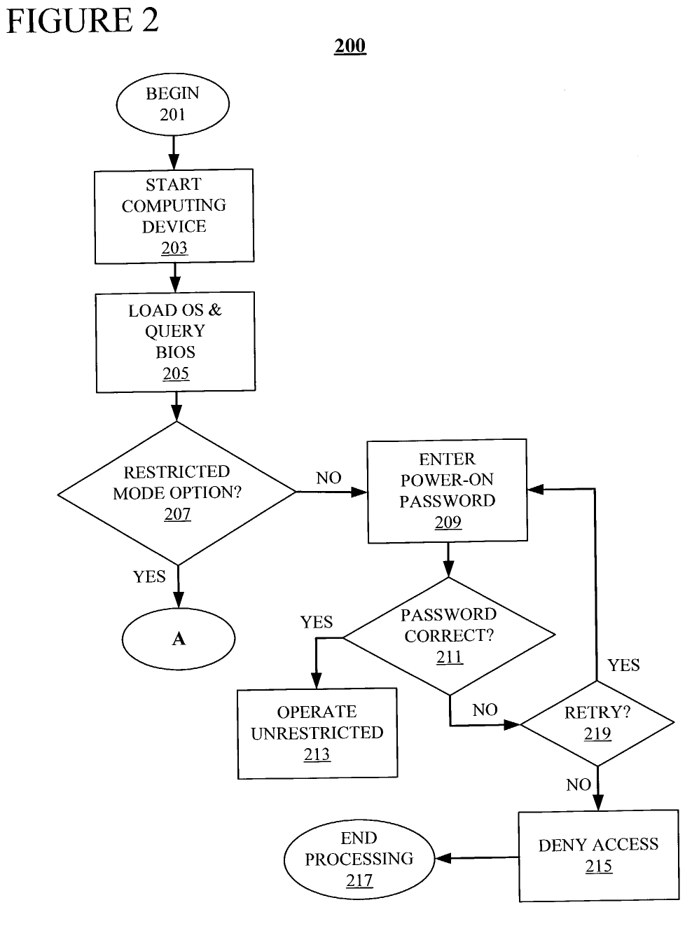

FIG. 2 is a flow chart showing a “Start-up and Initialization” routine 200 of the present invention. The Start-up routine 200 starts in a “Begin” step 201 and control immediately proceeds to a “Start Computing Device” step 203. Typically, the process 200, and consequently the Start Computing Device step 203, is initiated by a user turning on the power to a computing device such as PDA 100 (FIG. 1A) or the laptop computer 150 (FIG. 1B). In the alternative, the start-up process 200 can be initiated by the user by means of a device restart, e.g. by pressing a predetermined key or combination of keys such as keys 103 or 153. In order to simplify the following description, the figures will be explained in light of PDA 100, although it should be understood that the description is equally relevant to the laptop computer 150 and many other types of devices that employ access control, as explained above. In addition, the following description makes use of, in general, a password access control scheme and, more specifically, a power-on password, as described above in the Summary of the Invention. It should be noted that the present invention is equally applicable to other access control schemes as well as password protection schemes. For example, the disclosed embodiments may be implemented in conjunction with a fingerprint reader, a retinal scan device or any other access control scheme that uses software and/or hardware for protection.

From step 203, control proceeds to a “Load Operating System (OS) and Query Basic Input/Output System (BIOS)” step 205, in which the start-up routine 200 initializes the device 100 according to instructions stored in a BIOS memory (not shown). Stored within the BIOS is information as to whether the computing device supports the method of the present invention. After step 205, control proceeds to a “Restricted Mode Operation?” step 207 in which the routine 200 determines whether PDA 100 is configured to support the method of the disclosed embodiment. A “restricted” mode of operation is an operating mode in which access of a user of PDA 100 is limited to specified operations, data or devices. For example, in one particular implementation of the restricted mode, the user can create and store data records but cannot access previously stored data records. In another implementation, the user cannot access infrared capabilities (not shown) of PDA 100. It should be noted that in addition to data and other resources stored locally on PDA 100, the restrictions of any particular restricted mode also apply to data and other resources accessible via network connections.

If PDA 100 is not configured according to the method of the disclosed embodiment, control proceeds to an “Enter Power-On Password” step 209, in which the user is required to enter a password to access PDA 100. Of course, it should be noted that not all computing devices support a power-on or any other type of password or the password feature is disabled. In that case, the user would immediately have full access to the device and the following steps of process 200 are not executed. In addition to a password protection scheme, the disclosed embodiments are applicable to other types of computer access control methods such as biometric schemes, e.g. a fingerprint reader and a retinal scan device.

In step 209, once a user enters a password, control proceeds to a “Password Correct?” step 211 in which the password entered by the user is compared to a stored password. If the entered password matches the stored password, then control proceeds to an “Operate Unrestricted” step 213 in which all the resources of PDA 100 is available to the user. If, in step 211, the entered password does not match the stored password, then control proceeds to a “Retry?” step 219 in which the process 200 determines whether or not the user is permitted to enter the password again. If the user is not permitted to reenter the password because, for example, too many attempts have already been made, control proceeds to a “Deny Access” step 215. Control proceeds from the Deny Access step 215 to an “End Processing” step 217. If, in step 219, process 200 determines that the user may reenter the password, control proceeds to the Enter Power-On Password step 209 and processing proceeds as before.

If, in step 207, the process 200 determines that PDA 100 is configured to support the method of the disclosed embodiments, then control proceeds to an entry point A, the description of which continues in conjunction with FIG. 3.

FIG. 3 is a flow chart showing an exemplary “Operational Mode” process 300 of the present invention. Some disclosed embodiments support “compliant” applications, which are applications designed to implement both a restricted mode and an unrestricted mode, and legacy applications, which are not designed to operate in the restricted mode. In addition to an ability to operate in both a restricted mode and an unrestricted mode, a compliant application can be designed such that an installation program need only load those portions of the complaint applications that apply to a particular OS. For example, if the OS does not support the disclosed embodiments, the installation program may forgo installing corresponding libraries, thus conserving memory.

The entry point A is entered from step 207 (FIG. 2) when the Start-up procedure 200 has determined that the operating system of PDA 100 is configured to support the restricted mode of operation. Control proceeds from the entry point A to a “Notify Compliant Applications” step 301. In step 301, any compliant application, i.e. an application that is designed to be able to operate in the restricted mode or the unrestricted mode, executing on PDA 100 is notified by the operating system that PDA 100 is currently in the restricted mode. Typically, this notification is performed by means of well known mechanisms such as an application loader or via messages using interprocess communication (IPC). As will be recognized by those of skill in the computing arts, there are numerous ways in which any particular compliant application can implement the restricted mode. One method in which a specific compliant application may implement the restricted mode is to limit access to specific file system directories that store the application's data records. Another method may programmatically and selectively disable application functions such as those that retrieve data records.

Once compliant applications have been notified in step 301, control proceeds to a “Restore User Interface” step 303 in which a user interface displayed on the display screen 101 of PDA 100 is made accessible to the user of PDA 100. Once the user interface of PDA 100 has been restored, control proceeds to an “Operate in Restricted Mode” step 305. The disclosed restricted mode of operation is one in which specified applications are able to perform a limited number of operations prior to the entry of a password. For example, in the restricted mode, a note pad application allows a user of PDA 100 to enter and store new data but does not allow the user to access or modify stored data records.

UL icon 105 (FIG. 1) is included on the user interface for a user to easily access a program to transition PDA 100 from the restricted mode to an unrestricted mode. In the unrestricted mode, the user has unlimited access to all of the available resources and data records on PDA 100. UL icon 105 is one example of a mechanism for transitioning PDA 100 from a restricted mode to an unrestricted mode. Depending upon a particular user interface implementation other input mechanisms such as a defined series of keystrokes on the input keys 103 (FIG. 1) may be used alone or in addition to UL icon 105.

If the user elects to transition from the restricted mode to the unrestricted mode, whether by means of UL icon 105 or by some other means, control proceeds to a “Password Entered?” step 307 in which the user is prompted to enter a password to enable PDA 100 to make the transition. If an incorrect password is entered, the control returns to step 305 in which PDA 100 continues to operate in the restricted mode. Of course, the password entry step may include multiple opportunities to enter the correct password. If, in step 307, the correct password is entered, control proceeds to a “Notify Compliant Applications” step 309 in which the complaint applications are notified via IPC of the entry into the unrestricted mode and the applications take the necessary measures to enable the user to access previously unavailable data records and application functions. Control than proceeds to an “Operate in Unrestricted Mode” step 311 in which the user has full access to the normally accessible data records, application functions and devices.

From Operate in Unrestricted Mode step 311, control proceeds to an “Activate Restricted Mode?” step 315 in which process 300 determines whether the user has requested a transition from the unrestricted mode to the restricted mode. The user request can be initiated by means of a Lock icon (not shown) or by entry of a “rapid access” password, which is described in more detail below. If process 300 determines that the restricted mode has not been requested, then control proceeds to a “Timeout?” step 313 in which the process 300 monitors PDA 100 for periods of inactivity. If a predetermined amount of time has occurred since the last user activity on PDA 100, control proceeds to an “Enter Restricted Mode” step 317. If a timeout has not occurred, then control returns to step 311.

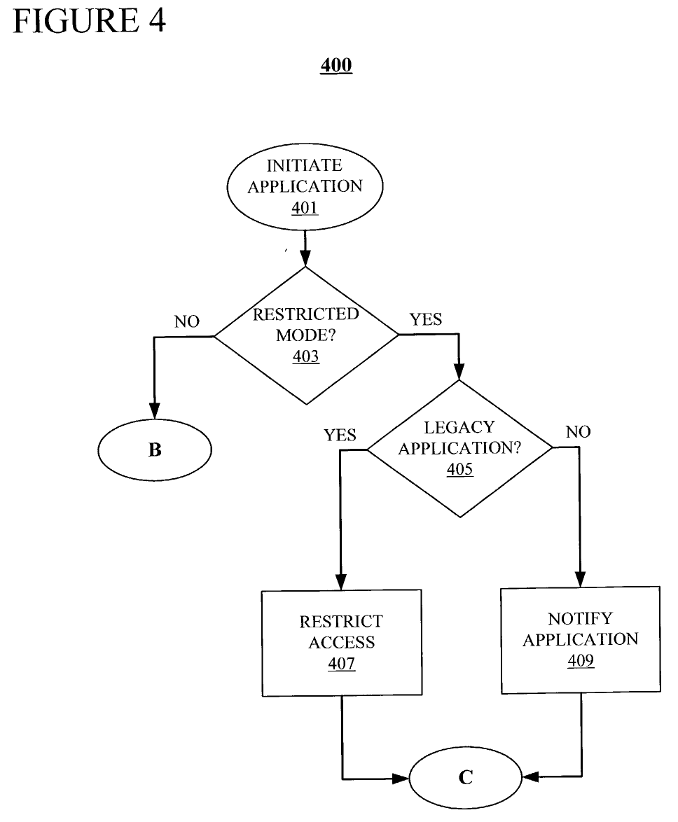

If, while in the Activate Restricted Mode?, step 315, the user requests to enter the restricted mode from the unrestricted mode, control proceeds to the Enter Restricted Mode step 317. From step 317, control proceeds to the Notify Compliant Applications step 301 and processing continues as explained above. In the absence of either a timeout in step 313 or an explicit user request to enter the restricted mode in step 315, PDA 100 continues to operate in the unrestricted mode. Of course, alternative configurations of step 315 and step 313 are possible. Entry points B and C are explained below in conjunction with FIG. 4.

FIG. 4 is a flow chart showing an “Application Initiation” process 400 in a computing system, such as PDA 100, implementing the present invention. In an “Initiate Application” step 401, either the user of PDA 100 initiates an application or an application is initiated automatically such as by a start up or routine maintenance script. As an example of a maintenance script, many computing systems include antivirus software or disk cleanup software that executes periodically. Typically, tasks associated with initiating an application, such as the tasks associated with the disclosed embodiments, are performed by the OS and/or an application loader program. From step 401, control proceeds to a “Restricted Mode?” step 403 in which the process 400 determines whether or not PDA 100 is currently operating in the restricted mode. If PDA 100 is not operating in the restricted mode, control proceeds to an Entry Point B, which is illustrated in the Restricted Mode process 300 of FIG. 3 as transferring control to the Operate In Unrestricted Mode step 311.

If in step 403, the process 400 determines that PDA 100 is operating in the restricted mode, then control proceeds to a “Legacy Application?” step 405 where process 400 determines whether the application initiated in step 401 is a compliant application, designed to operate in a restricted mode, or a legacy application. If the process 400 determines that the initiated application is a legacy application, then control proceeds to a “Restrict Access” step 407 in which the operating system takes steps to restrict directories or disks that contain stored data records corresponding to the initiated application. In addition, certain devices such as a printer may also be disabled. In an alternative embodiment, the restrictions may enable a user to read but not write data records. If in step 405, the process 400 determines that the application is a compliant application, then control proceeds to a “Notify Application” step 409 in which IPC is used to notify the compliant application of the currently operating restricted mode and the application takes the necessary measures to comply with the requirements of the mode. Regardless of whether control proceeds from step 405 to step 407 or step 409, control then proceeds to Entry Point C, which transfers control to the Operate In Restricted Mode step 305 illustrated above in conjunction with FIG. 3.

In an alternative embodiment, the methods of the present invention can work the same for all resources. In other words, rather than depending upon the existence of compliant applications or resources, all resources can be operated in the restricted mode by restricting any combination of file directories, data disks, functions or other operations of PDA 100 such as the disclosed embodiment describes in conjunction with legacy applications.

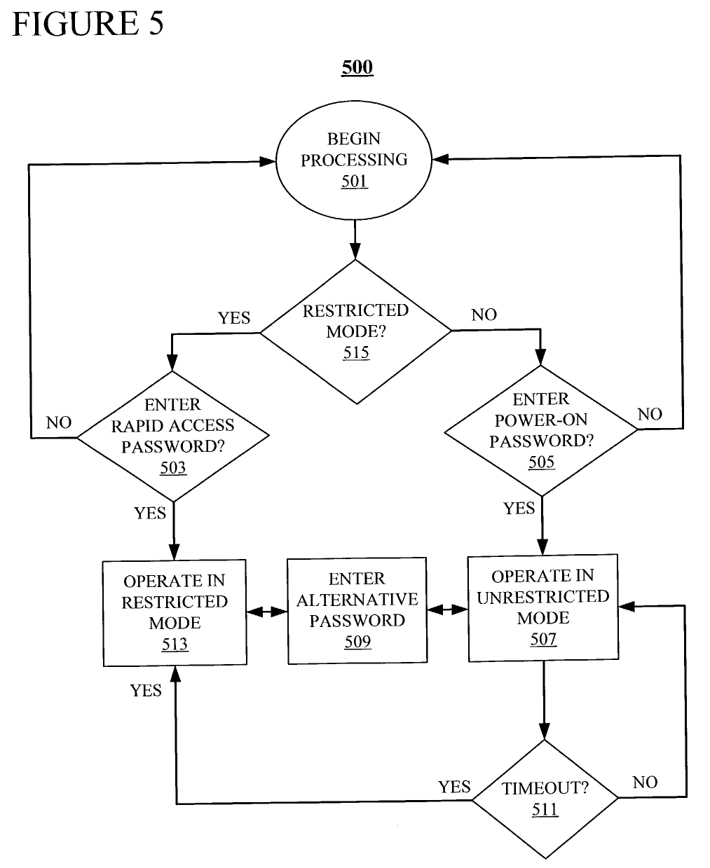

FIG. 5 is a flow chart of a “Rapid Access Password” process 500 that can be incorporated into the disclosed embodiment as described in conjunction with the figures above. A rapid access password is a second password used in addition to the power-on password. As explained above, a rapid access password is used as an example; other types of rapid access control data are equally applicable to the techniques of the disclosed embodiments. Typically, the rapid access password is shorter than the power-on password and thus can be entered more quickly. For example, the rapid access password may be as simple as a double-click of the stylus in a user specified area of the display screen 101 (FIG. 1) of PDA 100 or a short combination of two or more particular input keys 103 (FIG. 1).

Rapid Access Password process 500 begins in a “Begin Processing” step 501 and proceeds immediately to a “Restricted Mode?” step 515 in which the user determines which mode, restricted or unrestricted, to enter. The decision in step 515 is determined by whether the user enters the power-on password, typically in a password entry window (not shown), or enters the rapid access password. In the alternative, the user may indicate the requested mode by clicking on one of two corresponding icons (not shown). If the user elects to enter the restricted mode, control proceeds to an “Enter Rapid Access Password?” step 503. If the user elects to enter the unrestricted mode, then control proceeds to an “Enter Power-On Password?” step 505. In step 503, if the user correctly enters the rapid access password, then control proceeds to an “Operate In Restricted Mode” step 513. In step 505, if the user correctly enters the power-on password, then control proceeds to an “Operate In Unrestricted Mode” step 507. Although a power-on password is used as an example, the method of the disclosed embodiment is applicable to any password protection scheme. If, in step 503 or step 505, the corresponding password is entered incorrectly, control proceeds back to step 501.

If the user is in the restricted mode, as exemplified by step 513 and elects to enter the unrestricted mode, as exemplified by step 507, control proceeds to an “Enter Alternative Password” step in which the user enters the power-on password and control proceeds to step 507. As explained above in conjunction with FIG. 3, password entry can be initiated in the restricted mode by means of UL icon 105. If the user is in the unrestricted mode and elects to enter the restricted mode in order to prevent a subsequent user from accessing particular data or functions, control also proceeds to the Enter Alternative Password step 509 in which the user enters the rapid access password and control proceeds to step 513.

If while operating in the unrestricted mode, a timeout occurs, as indicated by a “Timeout?” step 511, control proceeds from the Timeout step 511 to the Operate In Restricted Mode 513. In other words, after a timeout, the user is not required to reenter the rapid access password in order to use PDA 100 in the restricted mode. In an alternative embodiment, the user may be required to reenter the rapid access password following a timeout.

While the invention has been shown and described with reference to particular embodiments thereof, it will be understood by those skilled in the art that the foregoing and other changes in form and detail may be made therein without departing from the spirit and scope of the invention, including but not limited to additional, less or modified steps performed in the same or a different order.

We claim:

1. A method of controlling access to a computing device, comprising the steps of:
providing a restricted mode of operation in which, prior to entry of access control data, the computing device provides access to a selected, non-null subset of functionality of at least one resource on the computing system;
providing an unrestricted mode in which the computing device provides access to full functionality of the resource; and
transitioning the computing device from the restricted mode to the unrestricted mode upon entry of the access control data.

2. The method of claim 1, wherein the access control data is a password.

3. The method of claim 1, further comprising the step of:
providing rapid access control data, wherein the rapid access control data is required for entry into the restricted mode.

4. The method of claim 3, wherein entry of the rapid access control data is not required for entry into the restricted mode from the unrestricted mode.

5. The method of claim 1, wherein the computing device transitions from the unrestricted mode to the restricted mode after a specified interval of inactivity on the computing device.

6. The method of claim 1, wherein the resource is an application.

7. The method of claim 6, wherein the selected, non-null subset does not include an ability to read stored data records corresponding to the application.

8. The method of claim 6, wherein the selected, non-null subset includes an ability to read stored data records corresponding to the application and does not include the ability to update the stored data records.

9. The method of claim 6, the step of providing a restricted mode of operation comprises the step of:
denying access to data storage areas of the computing device that contain previously stored data records corresponding to the application.

10. The method of claim 1, further comprising the step of:
transmitting a message to a complaint application to notify the compliant application that the computing device is in the restricted mode.

11. The method of claim 1, wherein the resource is a network resource.

12. A computing device, comprising:
a first access control scheme;
an unrestricted mode of operation; and
a restricted mode of operation in which the computing device permits access to a non-null subset of functionality of a resource on the computing device and does not permit access to a remaining portion of the functionality of the application;
wherein the restricted mode of operation is operable prior to entry of data corresponding to the first access control scheme and the unrestricted mode of operation is operable once the data has been entered.

13. The computing device of claim 12, wherein the subset of functionality includes the ability to create data records corresponding to the application and the remaining portion of the functionality includes access to stored data records corresponding to the application.

14. The computing device of claim 12, further comprising:
a second access control scheme;
wherein entry of rapid access control data corresponding to the second access control scheme is necessary for the computing device to operate in the restricted mode.

15. The computing device of claim 12, wherein the entry of the rapid access control data while the computing device is operating in the unrestricted mode transitions the computing device to the restricted mode.

16. The computing device of claim 15, wherein the entry of the rapid access control data is not required for the computing device to transition to the restricted mode if the computing device is in the unrestricted mode.

17. The computing device of claim 12, further comprising:
a user input for initiating a transition from the restricted mode to the unrestricted mode.

18. The computing device of claim 12, further comprising:
a message sent from an operating system to a compliant application loaded on the computing system to indicate to the compliant application whether or not the computing device is in the restricted mode of operation.

19. The computing device of claim 12, further comprising:
a file system corresponding to the application comprising a plurality of directories;
wherein a specified, non-null subset of the plurality of directories is inaccessible to the user while the computing device is operating in the restricted mode.

20. A computer program product for providing limited access to an application prior to entry of a password, comprising:
a recording medium;
means, recorded on the recording medium, for providing a restricted mode of operation in which, prior to entry of first access control data, a computing device provides access to a selected, non-null subset of functionality of a resource associated with the computing system;
means, recorded on the recording medium, for providing an unrestricted mode in which the computing device provides access to full functionality of the resource; and
means, recorded on the recording medium, for transitioning the computing device from the restricted mode to the unrestricted mode upon entry of the first access control data.

21. The computer program product of claim 20, wherein the first access control data is a power-on password.

22. The computer program product of claim 20, further comprising:
means, recorded on the recording medium, for providing a rapid access control scheme, wherein rapid access control data corresponding to the rapid access control scheme is required for entry into the restricted mode.

23. The computer program product of claim 22, wherein entry of the rapid access control data is not required for entry into the restricted mode from the unrestricted mode.

24. The computer program product of claim 23, wherein the computing device transitions from the unrestricted mode to the restricted mode after a specified interval of inactivity on the computing device.

25. The computer program product of claim 20, wherein the resource is an application.

26. The computer program product of claim 25, wherein the selected, non-null subset does not include an ability to read stored data records corresponding to the application.

27. The computer program product of claim 25, wherein the selected, non-null subset includes an ability to read stored data records corresponding to the application and does not include the ability to update the stored data records.

28. The computer program product of claim 20, the means for providing a restricted mode of operation comprises:
means, recorded on the recording medium, for denying access to data storage areas of the computing device that contain previously stored data records corresponding to the application.

29. A computer system application, comprising:
a restricted mode of operation that provides a selected, non-null subset of functionality of an application;
an unrestricted mode of operation that provides full functionality of the application; and
an input to initiate a transition between the restricted mode and the unrestricted mode.

30. The computer system application of claim 29, wherein the input is responsive to a message from an operating system of a computing device on which the application is loaded.

31. The computer system application of claim 29, wherein the input is responsive to an application loader program.

32. The computer system application of claim 29, wherein the restricted mode of operation includes the functionality of creating new data records corresponding to the application and excludes the functionality of reading stored data records corresponding to the application.

33. The computer system application of claim 29, wherein the restricted mode provides limited functionality by preventing access to selected file system resources corresponding to the application.

34. The computer system application of claim 29, wherein the restricted mode provides limited functionality by disabling selected functions of the application.
